(19) United States
(12) Patent Application Publication
(10) Pub. No.: US 2006/0153661 A1
(43) Pub. Date: Jul. 13, 2006

(54) Screw plug made of a metallic material, method for the production thereof, corresponding blank and corresponding tool

(76) Inventor: Hartmut Flaig, ALDINGEN (DE)

Correspondence Address: BACHMAN & LAPOINTE, P.C., 900 CHAPEL STREET, SUITE 1201, NEW HAVEN, CT, 06510, US

(21) Appl. No.: 10/539,925

(22) PCT Filed: Nov. 29, 2003
(86) PCT No.: PCT/EP03/13470

§ 371 Date: Jun. 16, 2005

(30) Foreign Application Priority Data
Dec. 16, 2002 (DE) 102 58 994.1
May 14, 2003 (DE) 103 21 544.1

(51) Int. Cl. F16L 55/11

(52) U.S. Cl. 411/378; 184/88.1

(57) ABSTRACT

A screw plug for a liquid conduit, particularly an oil pipe or an oil container, comprising a cylindrical shaft that is placed on a top plate and is provided with an external thread. A pocket hole having a polygonal cross section is centrally arranged on the top plate as a receiving member for a tool. The shaft is embodied as a tubular butt that is provided with the external thread. A pocket hole which is arranged coaxial to the pocket hole of the top plate extends from the face of the shaft. In order to produce the screw plug, a blank comprising the cylindrical tubular butt that is connected to the top plate in a molded on manner is made, the inner diameter and outer diameter of the tubular butt being smaller than the final corresponding diameters (e, f) of the screw plug. The tubular butt of the blank is then enlarged by applying pressure to the inner wall surface of the pocket hole thereof. Also disclosed is a tool in which one end of a pressure die is fixed as a mandrel-type tool while a supporting or holding head which is disposed so as to be movable relative thereto and encompass a seat for a blank is associated with the free end thereof.

### BACKGROUND OF THE INVENTION

The invention relates to a screw plug of metallic material for a fluid line, in particular for an oil line or oil tank, having a cylindrical shank, comprising an external thread, on a top plate in which a blind hole of polygonal cross section is provided centrally as a receiving member for a tool. In addition, the invention covers a method and a blank for manufacturing this screw plug and a tool for the production thereof.

Screw plugs of this type are used in particular in motor vehicles and have therefore to be produced in large numbers. It has hitherto proven favourable for the production thereof to have to be performed in at least three manufacturing stages. The object of the invention is to modify this in the direction of an improvement.

### SUMMARY OF THE INVENTION

The object is achieved by providing a screw plug of metallic material for a fluid line, in particular for an oil line or oil tank, having a cylindrical shank, comprising an external thread, on a top plate in which a blind hole of polygonal cross section is provided centrally as a receiving member for a tool, characterised in that the shank takes the form of a tube stub provided with the external thread and from the end face of the shank there extends a blind hole which is coaxial with the blind hole in the top plate and a method for producing same.

According to the invention, the shank takes the form of a tube stub provided with the external thread, a newly conceived blind hole which is coaxial with the conventional blind hole in the top plate extending from the end face of the shank of the screw plug. Of particular significance is the fact that, where a bevelled portion widening towards the top and inclined axis-wards from the top plate, at an angle in longitudinal section of preferably 30°, is provided as transition to the tube stub, the tube-ward foot contour of this bevelled portion is designed to be at the same time, structurally, an inner starting line for the external thread projecting radially beyond this contour. Furthermore, a diameter of 19.5 mm is preferred for the foot contour of the bevelled portion.

It has proven favourable for the deepest point of the blind hole in the tube stub to exhibit a cross-section inclined from the wall surface thereof to the longitudinal axis of the screw; advantageously, the depth of the wall surface should amount to around 8 mm, in particular 7.8 mm.

According to a further feature of the invention, the diameter of the blind hole measures around 14 mm and the external diameter of the external thread around 21 mm; the dimensions should in particular cover the values of 13.8 mm and 20.97 mm respectively.

The design of the screw plug according to the invention is also characterised in that at least one bevelled edge, preferably one on each side, inclined away from the free tube edge of the tube stub towards the top plate is associated with said tube edge, wherein the externally positioned bevelled edge is designed to develop into the external thread.

The invention in particular covers a method of producing this screw plug, in which a blank with a cylindrical tube stub formed on and adjoining a top plate is produced, whose internal diameter and external diameter are smaller than the corresponding diameters intended for the screw plug; the tube stub of the blank is expanded by simultaneously exerting pressure on the inner wall surface of the blind hole thereof. According to another feature of the invention, a plunger is driven as a mandrel-type tool into the blind hole in the tube stub blank and the walls of the tube stub are expanded radially thereby.

It has proven favourable, in this respect, for the outer surface of the tube stub to be forced out radially beyond the foot contour of the bevelled portion of the blank adjoining the top plate and inclined cross-sectionally axis-wards; the external thread is intended to be formed in the outer surface of the expanded tube stub, advantageously in the area of the tube stub determined in the axis-ward direction by said foot contour of the bevelled portion. This process of forming the thread in the outer surface is advantageously performed by a separate thread rolling process after the screw plug has been shaped as described above.

However, the invention also covers a method, in the course of which the outer surface of the tube stub is pressed during expansion thereof against a die surface surrounding it and comprising a negative of the thread.

Of particular significance is the blank used in the method to produce the screw plug; in said blank, the top plate is adjoined by a cylindrical tube stub with an external diameter and a blind hole diameter whose dimensions are smaller than those of the external diameter and hole diameter of the actual screw plug; the diameter of the blind hole should measure around 12 mm and the external diameter of the tube stub around 19 mm, preferably 19.2 mm. The dimensional difference relative to the end product is compensated by the expansion process.

It has also proven favourable for the external diameter of the tube stub on the blank to be smaller than the foot diameter of the bevelled portion on the screw plug; the latter bevelled portion, as well as the bevelled portion of the blank, should form an angle with the longitudinal axis of the blank which preferably measures around 30°.

According to another feature of the invention, a bevelled edge inclined away from the tube edge is also associated in each case on both sides with the tube edge of the tube stub, wherein the outer bevelled edge develops into the cylindrical outer tube surface.

Also of inventive significance is a tool with which shaping of the blank may be simply performed; according to the invention, a plunger is fixed at one end in a housing as a mandrel-type tool and the free end thereof is associated with a carrying or holding head arranged movably relative thereto and having a receptacle for a blank; the axis thereof extends in the central axis of the tool or the plunger. It is additionally favourable for a stationary base plate to be provided at the end of the bush-like housing remote from the carrying or holding head, which base plate forms an abutment for the plunger seated thereon. The free end of the plunger partially surrounded by a plunger tube is designed, according to the invention, to engage in a central bore in the carrying or holding head, wherein a pressure head of the plunger then projects axially beyond the edge of the mouth of the plunger tube. To this end, it has proven favourable for this plunger tube to be seated at its other end, preferably with a flange foot, on a stationary upright bush of the tool, which forms a bearing surface for the plunger passing through the upright bush. In order to improve the pressing process, a central pressure base may be formed on the base plate, forming a common abutment for the plunger and the upright bush.

The invention is also characterised in that the carrying or holding head of the tool is seated on a slide bush, which is associated coaxially with the plunger and the upright bush. The diameter of the pressure base is designed to match the diameter, seated thereon, of the slide bush.

The latter additionally comprises, on a foot portion associated with the pressure base, a head portion wider radially than said foot portion and is designed, with the holding head, to be surrounded supportingly by a guide chuck and to be axially movable therewith relative to the housing.

To assist in the movement of the base plate and the guide chuck, an energy storing device, in particular a profile element of resilient material, is arranged according to the invention between said tool parts. This profile element is preferably positioned in the manner of a ring around the pressure base of the base plate and may be made from strands of material of different cross-sectional shape.

Finally it has proven favourable for the blank seated in the carrying or holding head to be capable of being forced, on axial movement thereof, onto the pressure head of the plunger, wherein the diameter of the plunger is larger than the diameter of the blind hole in the blank, i.e. on insertion of the plunger the blank expands.

All in all, an attractively simple method is provided for producing the above-mentioned screw plugs.

### BRIEF DESCRIPTION OF THE DRAWINGS

Further advantages, features and details of the invention are revealed by the following description of a preferred exemplary embodiment and with reference to the drawings, in which

FIG. 1: is an oblique schematic view of a blank according to the invention for a screw plug;

FIG. 2: shows a diametral section through the screw plug;

FIG. 3: is a representation corresponding to FIG. 2 of the blank for producing the screw plug;

FIG. 4: shows a longitudinal section through a tool for producing the screw plug, with a blank inserted above a plunger prior to start of the shaping process;

FIG. 5: is a representation corresponding to FIG. 4 of the tool at the end of the shaping process with resultant screw plug;

FIG. 6: shows a longitudinal section through the plunger with associated blank.

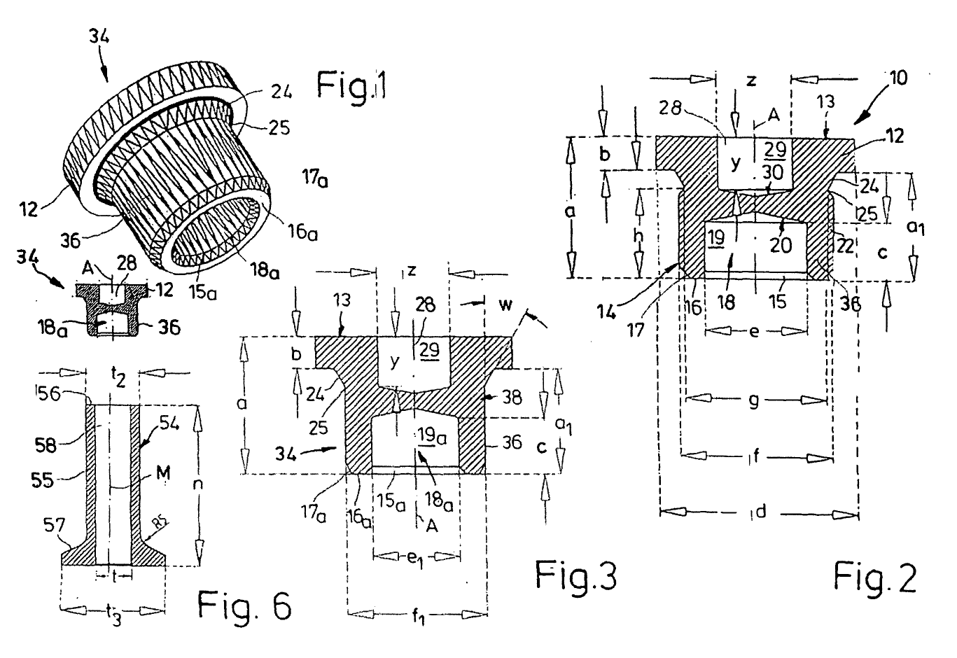

### DETAILED DESCRIPTION

A screw plug 10 for an oil line or an oil tank of a motor vehicle, not shown for reasons of clarity, comprises, formed on a disk-shaped top plate 12 of an axial height b of 4.5 mm and a diameter d of around 27 mm, a tube stub 14 of an external diameter f of 20.97 mm extending axially relative to the longitudinal axis A of the screw plug 10; the axial height a of the screw plug 10 measures 19 mm, from which a height c of 14.5 mm is calculated for the tube stub 14.

A blind hole 18 of a diameter e of 13.8 mm and a wall depth c of 7.8 mm is provided in the tube stub 14, extending from the end face thereof constructed as a tube edge 16, the deepest point 20 of said blind hole 18 being inclined centrally from the wall surface 19 of the blind hole towards the longitudinal axis A of the screw when viewed in cross-section, i.e. forms a flat conical surface. The tube edge 16 is associated with a bevelled edge 15 inclined towards the blind hole 18.

Such an inclined bevelled edge 17 also surrounds the tube edge 16 on the outside and develops into an external thread 22 of the external diameter f of 20.97 mm and the height h of 12 mm. A formed-in bevelled portion 24 of an axial height i of 2.5 mm, widening conically towards the top plate 12 at a cross-sectional angle w of 30° (see FIG. 3), adjoins the upper edge of the external thread 22. The edge-ward foot diameter g thereof measures 19.5 mm. The external thread 22 starts at the tube-ward foot contour 25 of the bevelled portion 24 and projects radially therebeyond.

From the surface 13 of the top plate 12 there extends a central blind hole 28 of hexagonal cross section of a diameter z of around 4.8 mm (SW 10) and a wall depth y of 7 mm. The deepest point 30 of this hole is also inclined centrally from the wall surface 29 towards the longitudinal axis A of the screw, likewise forming a flat conical surface. A tool, not shown in the drawings, is inserted into this top blind hole 28 for turning the screw plug 10.

To produce the screw plug 10, a blank 34 illustrated in FIG. 3 of metal (of 19MnB₄ for example) is made, comprising the top plate 12, containing the top blind hole 28, together with a cylindrical tube stub 36 formed thereon; while the top plate 12 corresponds in its dimensions and those of its blind hole 30 (b, d, y, z) to those of the finished screw plug 10, the tube stub 14 thereof differs in configuration from the tube stub 36 of the blank 34. The outer tube surface 38 here starts at the end of the inclined bevelled portion 24, likewise exhibiting the final dimensions g, w, remote from the top plate 12; the diameter f₁ of its cylindrical contour amounts to 19.2 mm, and is therefore 1.77 mm smaller than the external diameter f in the case of the finished screw plug 10. The diameter e₁ of the blind hole 18ₐ present in the blank 34 and adjoining the inner bevelled edge 15ₐ of the tube edge 16ₐ measures 12 mm, and is therefore 1.8 mm smaller than the diameter e in the case of the finished screw plug 10. The outer bevelled edge is here designated 17ₐ.

To produce the screw plug 10 from the blank 34, the tube stub 36 thereof is expanded, for instance by driving a mandrel into the blind hole 18ₐ and exerting pressure on the wall surface 19ₐ of the latter, dimensionally accurately into the tube stub 14, wherein the external thread 22 may be formed without difficulty.

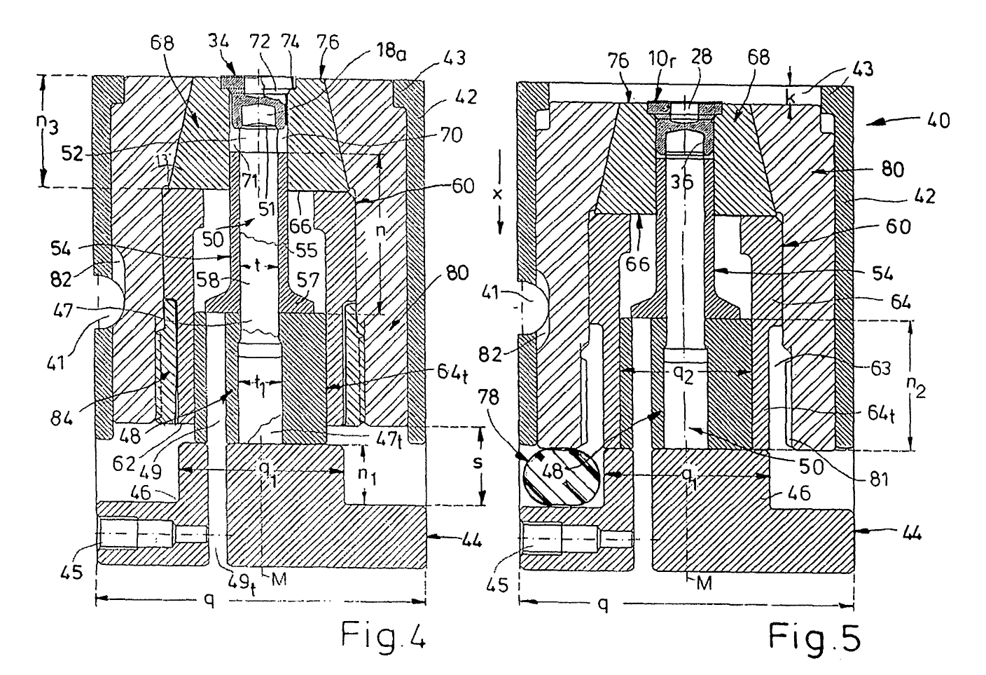

A tool 40 for a preferred method of producing the screw plug 10 is revealed in FIGS. 4 to 6. Coaxially with the central axis M thereof, a base plate 44 with centrally formed-on pressure base 46 of a diameter q₁ of 60 mm and a height n₁ of 21.5 mm and with a radial stepped bore 45 is associated with a cylindrical tool housing 42 of an external diameter q of for example 120 mm.

An upright bush 48 of a length n₂ of approximately 47 mm, with an axial bore 47 which offers a cross-sectionally wider end portion 47ₜ of a diameter t₁ of 16 mm, is seated on the pressure base 46. This axial bore 47, 47ₜ accommodates a plunger 50 constituting a mandrel-type tool, which is surrounded above the upright bush 48 by a plunger tube 54 of a length n of virtually 60 mm, consisting of a tube portion 55 with a flange foot 57 formed thereon at one end of a diameter t₃ of around 40 mm; the external tube diameter t₂ measures 21 mm, the internal diameter t of the inside 58 of the tube around 14 mm. The latter is continued downwards by the axial bore 47 of the upright bush 48. Adjacent the axial bore 47, 47ₜ and at a radial distance therefrom there extends in the upright bush 48 an additional axially parallel bore 49 of smaller diameter, which is aligned with a corresponding bore 49ₐ in the base plate 44.

A slide bush 60 of a height of around twice the above-mentioned length n₂ is fitted externally on the upright bush 48 of diameter q₂; the lower edge 62 of said slide bush is seated in FIG. 5 on the central pressure base 46 of the base plate 44. The cylindrical outer surface of the lower half or the foot portion 64ₜ of the slide bush 60 continues the outer surface of the pressure base 46 and defines a cylindrical cavity 63. At a distance from the lower edge 62 corresponding approximately to the length n₂ of the upright bush 48 there begins a broader head portion 64 of the slide bush 60, which bears on its top face 66 a holding head 68, of upwardly tapering cross-section, with a central bore 70; this accommodates the upper end of the tube portion 55 of the plunger tube 54, whose external diameter t₂ determines the diameter of the bore 70. The height n₃ of the holding head 68 is slightly smaller than the length n₂ of the upright bush 48.

Between the outer tool housing 42 on the one hand and the slide bush 60 and the holding head 68 on the other there extends a guide chuck 80 filling the space and likewise resembling a bush. This surrounds the slide bush 60 and the holding head 64 in form-fitting manner and may be displaced axially in the tool housing 42 as a unit together with these inner parts. In the area of the cavity 63, it is provided with a thread 81 for a screw bush 84, which extends in said cavity 63.

43 denotes a guide edge of the housing 42 directed towards the central axis M, and 41 denotes a radial guide member, which engages in an axially parallel guide recess 82 in the guide chuck 80.

The top portion of the bore 70 is adapted cross-sectionally to the structural configuration of the screw plug 10, i.e. the diameter of the bore 70 corresponds, with slight play, to the external diameter f of the tube stub 14 of the screw plug 10 and widens, for instance at a distance from the end face 76 of the holding head 68 corresponding to the axial height b of the top plate 12, from a conical annular plane 72 of the bore wall 71, corresponding to the inclined bevelled portions 24 of the screw plug 10, as far as a step 74, on which the top plate 12 of the blank 34 is positioned according to FIG. 4. The circumference of the tube stub 36 thereof extends with annular spacing relative to the bore wall 71 of the central bore 70.

During this insertion process, the bevelled edge 15ₐ of the blank 34 stands, at a distance from the edge 56 of the mouth of the tube portion 55, on the correspondingly inwardly sloping top or bevelled edge 51 of the end-ward portion or pressure head 52 of the plunger 50, which projects correspondingly beyond the edge 56 of the mouth of the plunger 54. The diameter of this top edge 51 corresponds to the diameter e of the blind hole 18 of the screw plug 10, i.e. it is larger than the corresponding diameter e₁ on the blank 34.

For the pressing or shaping process, the guide chuck 80 is lowered inside the housing 42 in the shaping direction x towards the base plate 44 against a profile ring of resilient material indicated at 78 and of approximately circular cross-section, i.e. the spacing s between them is reduced, wherein the plunger or pressure head 52 of the stationary plunger 50 penetrates into the blind hole 18ₐ in the blank 34 and expands the tube stub 36 until the outer surface 38 thereof lies against the bore wall 71 of the bore 70. The pressing distance k, which is here 7 mm, is shown in FIG. 5. The profile ring 78 arranged between base plate 44 and guide plate 80 may, moreover, be of different cross-sectional configuration than is shown schematically in FIG. 5, optionally it may take the form of a hollow profile.

After the shaping process, the still not quite finished screw plug 10ᵣ is removed from the holding head 68 and its expanded tube stub 36 is provided with an external thread 22; then the screw plug 10 is ready for use.

1-36. (canceled)

37. A screw plug of metallic material comprising a cylindrical shank (36), having an external thread (22), a top plate (12) in which a blind hole (28) of polygonal cross section is provided centrally as a receiving member for a tool, the shank (36) having the form of a tube stub (14) provided with the external thread (22) and from an end face (16) of the shank there extends a further blind hole (18) which is coaxial with the blind hole (28) in the top plate (12).

38. A screw plug comprising a bevelled portion (24) inclined axis-wards from a top plate (12) as a transition to the shank (36), wherein a tube-ward foot contour (25) of the bevelled portion constitutes an inner starting line for an external thread (22) projecting radially beyond the foot contour.

39. A screw plug according to claim 38, wherein the bevelled portion (24), widening towards the top, of the screw plug (10) forms an angle (w), in longitudinal section, with the longitudinal axis (A) of the screw, which angle measures about 30°.

40. A screw plug according to claim 38, wherein a diameter (g) of the foot contour (25) of the bevelled portion (24) of 19.5 mm.

41. A screw plug according to claim 37, wherein a deepest point (20) of the further blind hole (18) in the tube stub (14) exhibits a cross-section inclined from a wall surface (19) thereof to a longitudinal axis (A) of the screw.

42. A screw plug according to claim 41, wherein a depth (c) of the wall surface (19) of between 7.8 mm and 8 mm.

43. A screw plug according to claim 37, wherein a diameter (e) of the further blind hole (18) of about 14 mm and an external diameter (f) of the external thread (22) of about 21 mm.

44. A screw plug according to claim 37, wherein associated with the tube edge (16) is at least one bevelled edge (15 or 17) inclined away therefrom towards the top plate.

45. A screw plug according to claim 44, wherein a bevelled edge (15, 17) inclined away from the tube edge towards the top is associated in each case on both sides with the tube edge (16).

46. A screw plug according to claim 45, wherein the outer bevelled edge (17) develops into the external thread (22).

47. A method of producing a screw plug according to claim 37, comprises producing a blank (34) with a cylindrical tube stub (36) formed on and adjoining a top plate (12) whose internal diameter (e₁) and external diameter (f₁) are smaller than the corresponding diameters (e, f) intended for the screw plug (10), and in that the tube stub (36) of the blank is expanded by exerting pressure on the inner wall surface (19ₐ) of the blind hole (18ₐ) thereof.

48. A method according to claim 47, wherein a portion (52) of a plunger (50) of larger cross-section than the internal diameter (e₁) of the blind hole (18ₐ) in the tube stub (36) of the blank (34) is introduced into said blind hole as a mandrel-type tool and the tube stub is expanded radially thereby.

49. A method according to claim 47, wherein the outer surface (38) of the tube stub (36) is forced out radially beyond the foot contour (25) of a bevelled portion (24) adjoining the top plate (12) and inclined cross-sectionally axis-wards.

50. A method according to claim 47, wherein an external thread (22) is formed in an outer surface (38) of the expanded tube stub (36).

51. A method according to claim 50, wherein the external thread (22) is formed in the area of the tube stub (36) determined in the axis-ward direction by the foot contour (25) of the bevelled portion (24).

52. A method according to claim 50, wherein the external thread (22) is formed in the outer surface (38) of the tube stub (36) by the thread rolling method.

53. A method according to claim 50, wherein the outer surface (38) of the tube stub (36) is pressed against a die surrounding it.

54. A blank for producing a screw plug (10) according to claim 37, comprising a top plate (12) of the blank (34) is adjoined by a cylindrical tube stub (36) with an external diameter (f₁) and a diameter (e₁) of the blind hole (18ₐ) whose dimensions are smaller than those of the external diameter (f) and hole diameter (e) of the screw plug (10).

55. A blank according to claim 54, wherein the external diameter (f₁) of the tube stub (36) on the blank (34) is smaller than the foot diameter (g) of the bevelled portion (24) on the screw plug (10).

56. A blank according to claim 55, wherein the bevelled portion (24) of the blank (34) forms an angle (w) with the longitudinal axis (A) of the blank which preferably measures around 30°.

57. A blank according to claim 55, wherein a diameter (e₁) of the blind hole (18ₐ) of about 12 mm and an external diameter (f₁) of the tube stub (36) of about 19 mm.

58. A blank according to claim 54, wherein a bevelled edge (15ₐ, 17ₐ) inclined away from a tube edge is associated in each case on both sides with the tube edge (16ₐ) of the tube stub (36).

59. A blank according to claim 58, wherein the outer bevelled edge (17ₐ) of the tube stub (36) develops into the cylindrical outer tube surface (38).

60. A tool for producing a screw plug (10) according to claim 37, wherein a plunger (50) is fixed at one end in a housing (42) as a mandrel-type tool and the free end thereof is associated with a carrying or holding head (68) arranged movably relative thereto and having a receptacle for a blank (34), wherein the axis (A) thereof extends in the central axis (M) of the tool (40) or the plunger.

61. A tool according to claim 60, wherein a stationary base plate (44) is associated with the bush-like housing (42) at the end remote from the carrying or holding head (68), which base plate forms an abutment for the plunger (50) seated thereon.

62. A tool according to claim 61, wherein a free end of the plunger (50) partially surrounded by a plunger tube (54) engages in a central bore (70) in the carrying or holding head (68), wherein a pressure head (52) of the plunger projects axially beyond the edge (56) of the mouth of the plunger tube.

63. A tool according to claim 62, wherein the plunger tube (54) is seated at its other end, preferably with a flange foot (57), on a stationary upright sleeve (48) of the tool (40), which forms a bearing surface for the plunger (50) passing through the upright sleeve.

64. A tool according to claim 63, wherein a disk-like central pressure base (46) of the base plate (44) as an abutment for the plunger (50) and the upright bush (48).

65. A tool according to claim 64, wherein the carrying or holding head (68) is seated on a slide bush (60), which is associated coaxially with the plunger (50) and the upright bush (48).

66. A tool according to claim 65, wherein a diameter (q₁) of the pressure base (46) approximately matches the diameter seated thereon of the slide bush (60).

67. A tool according to claim 66, wherein on a foot portion (64ₜ) associated with the pressure base (46), the slide bush (60) comprises a head portion (64) wider radially than said foot portion.

68. A tool according to claim 67, wherein the slide bush (60), with the holding head (68), is surrounded supportingly by a guide chuck (80) and arranged to be axially movable therewith relative to the housing (42).

69. A tool according to claim 68, wherein an energy storing device (78) is arranged between the base plate (44) and the guide chuck (80).

70. A tool according to claim 69, wherein the energy storing device takes the form of a profile element (78) of resilient material.

71. A tool according to claim 70, wherein the energy storing device or profile element (78) is positioned in the manner of a ring around the pressure base (46) of the base plate (44).

72. A tool according to claim 7, wherein the blank (34) seated in the carrying or holding head (68) is arranged so as to be forceable, on axial movement thereof, onto the pressure head (52) of the plunger (50), wherein the diameter thereof is larger than the diameter (e₁) of the blind hole (18ₐ) in the blank.
